(19) United States
(12) Patent Application Publication
(10) Pub. No.: US 2018/0194070 A1
(43) Pub. Date: Jul. 12, 2018

(54) 3D PRINTING USING PREFORMED REUSEABLE SUPPORT STRUCTURE

(71) Applicant: Stratasys Ltd., Rehovot (IL)

(72) Inventors: Daniel DIKOVSKY, Ariel (IL); Shai HIRSCH, Rehovot (IL)

(21) Appl. No.: 15/751,175

(22) PCT Filed: Aug. 8, 2016
(86) PCT No.: PCT/IL2016/050864

§ 371 Date: Feb. 8, 2018

Related U.S. Application Data
(60) Provisional application No. 62/202,934, filed on Aug. 10, 2015.

(51) Int. Cl. B29C 64/40; B29C 64/209; B29C 64/386

(52) U.S. Cl. CPC B29C 64/40; B29C 64/386; B29C 64/209

(57) ABSTRACT

A system includes a three-dimensional (3D) printer, a processor configured to compute object data for printing the object and a controller. The object data is defined in a layer-wise manner and the object data of one layer defines selective dispensing to different distances. The controller is configured to control the dispensing of the building material in the layer-wise manner based on the object data. The printing includes a dispensing unit for selectively dispensing building material in a layer-wise manner for building the object and a building tray for supporting the dispensed material for building the object. The printing further includes use of a prefabricated support structure, and printing at least a portion of the object over the prefabricated support structure.

### RELATED APPLICATION/S

This application claims the benefit of priority under 35 USC § 119(e) of U.S. Provisional Patent Application No. 62/202,934 filed Aug. 10, 2015, the contents of which are incorporated herein by reference in their entirety.

### FIELD AND BACKGROUND OF THE INVENTION

The present invention, in some embodiments thereof, relates to an additive manufacturing method and, more particularly, but not exclusively, to three dimensional (3D) printing for bulk production.

Additive manufacturing is generally a process in which a 3D object is manufactured utilizing a computer model of the object. Such a process is used in various fields, such as design related fields for purposes of visualization, demonstration and mechanical prototyping, as well as for rapid manufacturing.

Additive manufacturing entails many different approaches to the method of fabrication, including three-dimensional printing, laminated object manufacturing, fused deposition modeling and others.

In three-dimensional printing processes, for example, a building material is dispensed from a dispensing head having a set of nozzles to deposit layers on a supporting structure. Depending on the building material, the layers may then be cured or solidified using a suitable device. The building material may include modeling material, which forms the object, and support material, which supports geometry of the object as it is being built. Various three-dimensional printing techniques exist and are disclosed in, e.g., U.S. Pat. Nos. 6,259,962, 6,569,373, 6,658,314, 6,850,334, 7,183,335 7,209,797, 7,225,045, 7,300,619, 7,479,510, 7,500,846, 7,658,976 and 7,962,237, and U.S. Published Application No. 20100191360, all of the same Assignee, the contents of which are hereby incorporated by reference.

### SUMMARY OF THE INVENTION

According to an aspect of some embodiments of the present invention there is provided a method manufacturing an object by 3D printing using a prefabricated support structure for supporting geometry of the object while it is being built. According to some embodiments of the present invention, a surface of the prefabricated support structure on which the 3D printer dispenses material is not flat. In some exemplary embodiments, at the termination of the 3D printing process, the support structure is separated from the object and used again for printing an additional object, e.g. for printing a duplicate object.

An aspect of some embodiments of the present invention provides for a system comprising: a three-dimensional (3D) printer comprising: a dispensing unit for selectively dispensing building material in a layer-wise manner for building an object; and a building tray for supporting the dispensed material for building the object; a processor configured to compute object data for printing the object, wherein the object data is defined in a layer-wise manner, and wherein the object data of one layer defines selective dispensing to different distances; and a controller configured to control the dispensing of the building material in the layer-wise manner based on the object data.

Optionally, the system includes a prefabricated support structure configured to support a shape of the object, wherein at least a portion of the building material is dispensed over the prefabricated support structure and wherein the prefabricated support structure is configured to be reusable.

Optionally, the prefabricated support structure is formed by an additive manufacturing process.

Optionally, the prefabricated support structure is formed with modeling material or with support material that is coated with a lacquer.

Optionally, the object data is defined to follow a contour of a prefabricated support structure over which at least a portion of the object is built.

Optionally, the prefabricated support structure is configured to be separated from the object after construction of the object.

Optionally, the processor is configured to identify a discrete volume requiring a support structure from a computer model of the object and to adapt the object data to follow a contour of the volume.

Optionally, the building material includes modeling material.

Optionally, the building material includes support material.

An aspect of some embodiments of the present invention provides a method comprising: selecting a prefabricated support structure for supporting geometry of an object during manufacturing by 3D printing; computing object data for printing the object, wherein the object data is defined in a layer-wise manner and object data of a layer is defined to follow a contour of the prefabricated support structure that is curved or angled; and dispensing building material selectively over the prefabricated support structure in a layer-wise manner to manufacture the object.

Optionally, the building material of the layer is dispensed to different distances.

Optionally, the method includes separating the prefabricated support structure from the object after manufacturing the object.

Optionally, the method includes reusing the prefabricated support structure for manufacturing an additional object.

Optionally, the prefabricated support structure is formed by an additive manufacturing process.

Optionally, the prefabricated support structure is formed by 3D printing with modeling material.

Optionally, the prefabricated support structure is formed by 3D printing with support material that is coated with lacquer.

Optionally, the prefabricated support structure is manufactured by injection molding.

Optionally, the prefabricated support structure is formed with metal.

Optionally, the prefabricated support structure is coated with a film.

Optionally, the building material is modeling material.

Optionally, the building material includes support material.

Optionally, the method includes identifying a discrete volume requiring a support structure from a computer model of the object; and manufacturing the prefabricated support structure in the shape of the discrete volume.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram of an exemplary 3D printing system in accordance with some embodiments of the present invention;

FIGS. 2A, 2B, 2C and 2D are simplified schematic drawings showing construction of an object with a prefabricated support structure over four exemplary steps in accordance with some embodiments of the present invention;

FIG. 3 is a simplified schematic drawing of an exemplary computer object data of an object, the data adapted according to shape of a prefabricated support structure in accordance with some embodiments of the present invention;

FIGS. 4A, 4B, 4C and 4D are simplified schematic drawings showing construction of an object with a plurality of prefabricated support structures over four exemplary steps in accordance with some embodiments of the present invention;

FIG. 5 is a simplified block diagram of an exemplary method for adjusting 3D printing for printing on a prefabricated support structures in accordance with some embodiments of the present invention; and

FIG. 6 is a simplified block diagram of an exemplary method for 3D printing with prefabricated support structures in accordance with some embodiments of the present invention.

### DESCRIPTION OF SPECIFIC EMBODIMENTS OF THE INVENTION

The present invention, in some embodiments thereof, relates to an additive manufacturing method and, more particularly, but not exclusively, to 3D printing for bulk production.

According to some embodiments of the present invention, one or more prefabricated support structures are introduced before and/or during 3D printing to support a printed object. The prefabricated support structures are used in place of support structures that are formed with support material during 3D printing of the object. Since the prefabricated support structures are already constructed, less material is required to be dispensed to complete construction of the object and the printing time can be reduced. Optionally, when using prefabricated support structures, one or more of the printing heads that would otherwise be used to dispense support material can be replaced with printing heads for dispensing the modeling material. Dedicating more printing heads for printing the object itself also reduces the printing time required to complete construction of the object. Optionally, at least one of the printing heads is used to print support material, while using one or more prefabricated support structures to support additional volumes while constructing the object.

According to some embodiments of the present invention, the pre-fabricated support structure is separated and/or detached from the printed object at the end of the printing process and is subsequently used for manufacturing additional objects. Optionally, geometry of the pre-fabricated support structure is defined based on a computer model of the object for manufacture. According to some embodiments of the present invention, the pre-fabricated support structure is more easily detached from the object as compared to a support structure that is printed with the object itself. Known methods for removing support structures built with modeling material during 3D printing are known to be labor intensive and time consuming. In addition, quality of the surface of the object that is exposed after removal of the printed support material is typically poor.

According to some embodiments of the present invention, the material used to construct the pre-fabricated support is harder than the support material used in 3D printing. Optionally, the prefabricated support structure is formed by 3D printed modeling material, metal, injection molding, and 3D printing support material coated with a harder coating, e.g. lacquer so it can be used multiple times. According to some embodiments of the present invention the prefabricated support structure is coated with a material to facilitate separating the object from the prefabricated support structure. Optionally, polyethylene (PE) film is used to coat a surface of the prefabricated support structure on which the object is to be printed. The prefabricated support structure can be prefabricated by known manufacturing methods including but not limited to additive manufacturing, milling with computer numerical control (CNC) or by molding, e.g. injection molding. Typically, the surface of the object that is exposed after removal of the prefabricated support structure is of improved quality over the surface exposed after removing printed support material. According to some embodiments of the present invention, the pre-fabricated support structure facilitates mass customization and mass production with 3D printing. Alternatively, the prefabricated support structure is part of the item for manufacture and is not separated from the object.

According to some embodiments of the present invention, a 3D printer dispenses material over a plurality of layers in a defined pattern corresponding to a shape of the object for manufacture and a shape of one or more prefabricated support structure over which the object is built. The term “object” as used herein refers to a whole object or a part thereof. Typically, the pattern is defined with generated computer object data.

According to some embodiments of the present invention, computer object data defines layers that are adapted to follow a contour of the prefabricated support structure over which the layers are deposited. The 3D printer is operated to deposit material on the prefabricated support structure over different distances according to the contour of the prefabricated support structure. According to some embodiments of the present invention, the 3D printer is also operated to cure the deposited material from different distances according to the contour of the prefabricated support structure.

The computer object data can be in any known format, including, without limitation, a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY) or any other format suitable for Computer-Aided Design (CAD).

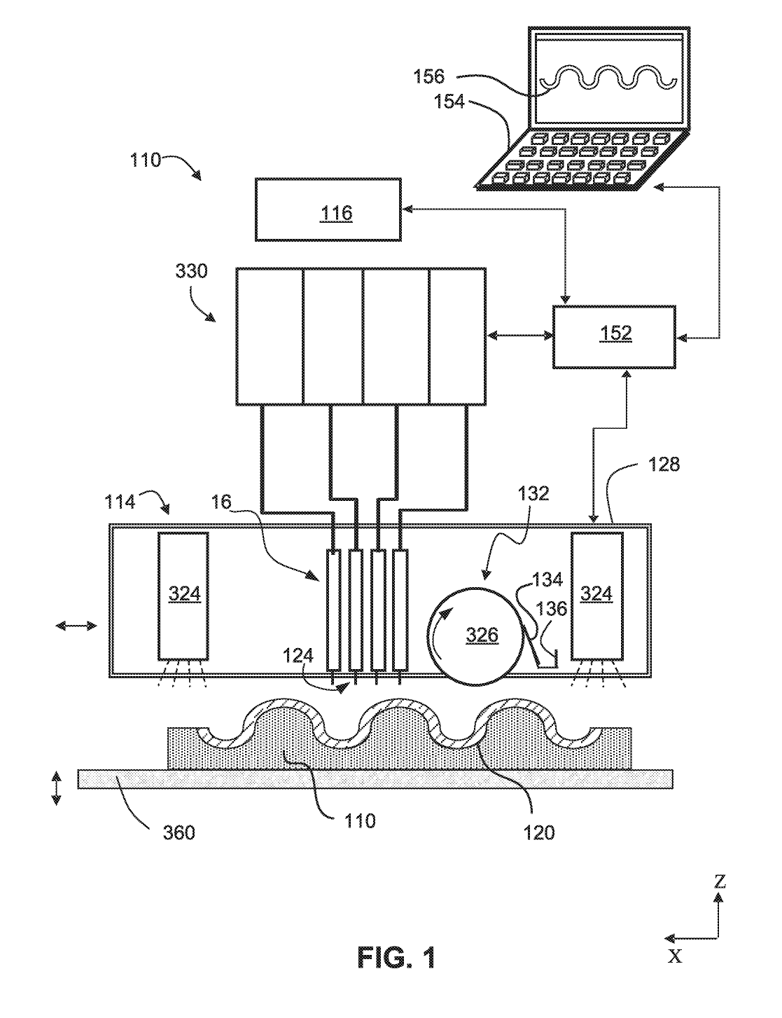

Reference is now made to FIG. 1 showing a simplified block diagram of an exemplary 3D printing system in accordance with some embodiments of the present invention. System 110 includes 3D printing apparatus 114 for printing an object 120 over a building tray 360. A control unit 152 controls 3D printing apparatus 114 and optionally and preferably also controls supply system 330 which comprises the building material containers or cartridges and supplies a plurality of building materials to apparatus 114.

Control unit 152 typically includes an electronic circuit configured to perform the controlling operations. Control unit 152 preferably communicates with a data processor 154 which transmits digital data pertaining to construction instructions for constructing an object 120 based on computer object data, e.g., a CAD configuration represented on a computer readable medium in a form of a Standard Tessellation Language (STL) format or the like. Once the manufacturing data is loaded to control unit 152 it can operate without user intervention. In some embodiments, control unit 152 receives additional input from the operator, e.g., using data processor 154 or using a user interface 116 communicating with control unit 152. User interface 116 can be of any type known in the art, such as, but not limited to, a keyboard, a touch screen and the like. For example, control unit 152 can receive, as additional input, availability of one or more pre-fabricated objects, one or more building material types and/or attributes, such as, but not limited to, color, characteristic distortion and/or transition temperature, viscosity, electrical property, magnetic property. Other attributes and groups of attributes are also contemplated.

3D printing apparatus 114 typically includes a dispensing unit 16 housing a plurality of printing heads. Each printing head preferably comprises an array of one or more nozzles 124 through which a liquid building material is dispensed. Optionally, the building material is dispensed via inkjet technology.

3D printing apparatus 114, also typically includes one or more leveling devices 132, e.g. a roller 326. Leveling device 326 is operated to remove excess material from an upper surface so as to level and/or establish a thickness of the newly formed layer prior to the formation of the successive layer thereon. Leveling device 326 preferably includes a scraper 134 for scraping the excess material collected by roller 326 and a waste collection device 136 for collecting the excess material. Waste collection device 136 may include any mechanism that delivers the excess building material to a waste tank or waste cartridge. Optionally, leveling is not required when 3D printing is operated to form a thin shell over the pre-fabricated support structure. Alternatively, some portions of the contour over the pre-fabricated support structure is not leveled.

3D printing apparatus 114 can further include one or more hardening devices 324 which can include any device configured to emit light, heat or the like that may cause the deposited material to harden. For example, hardening device 324 can comprise one or more radiation sources, which can be, for example, an ultraviolet or visible or infrared lamp, or other sources of electromagnetic radiation, or electron beam source, depending on the modeling material being used. In some embodiments of the present invention, hardening device 324 serves for curing or solidifying the building material. Optionally, hardening device 324 is operated to cure or solidify material in a range of distances. Optionally, intensity of electromagnetic radiation is adjusted for curing portions of the layer that are more distanced from the source of radiation as compared to other portions of the layer.

Elements included in 3D printing apparatus 114 are preferably mounted in a frame or block 128 which is preferably operative to reciprocally move over tray 360, which serves as the working surface. In some embodiments of the present invention, hardening devices 324 are mounted on the block 128 such that they follow in the wake of the dispensing heads to at least partially cure or solidify the materials just dispensed by the dispensing heads. Tray 360 is positioned horizontally. According to the common conventions an X-Y-Z Cartesian coordinate system is selected such that the X-Y plane is parallel to tray 360. Tray 360 is preferably configured to move vertically (along the Z direction), typically downward.

In use, the dispensing heads of unit 16 move in a scanning direction, which is referred to herein as the X direction, and selectively dispense building material in a predetermined configuration in the course of their passage over tray 360. The building material typically includes one or more types of modeling material and optionally one or more types of support material. Typically, control unit 152 controls the voltage applied to each dispensing head or nozzle array and the temperature of the building material in the respective printing head.

The passage of the dispensing heads of unit 16 is followed by the curing of the modeling material(s) using hardening device 324. In the reverse passage of the heads, back to their starting point for the layer just deposited, an additional dispensing of building material may be carried out, according to predetermined configuration. In the forward and/or reverse passages of the dispensing heads, the layer thus formed may be straightened by leveling device 326, which preferably follows the path of the dispensing heads in their forward and/or reverse movement. Once the dispensing heads return to their starting point along the X direction, they may move to another position along an indexing direction, referred to herein as the Y direction, and continue to build the same layer by reciprocal movement along the X direction. Alternately, the dispensing heads may move in the Y direction between forward and reverse movements or after more than one forward-reverse movement. The series of scans performed by the dispensing heads to complete a single layer is referred to herein as a single scan cycle.

Once the layer is completed, tray 360 is lowered in the Z direction to a predetermined Z level, according to the desired thickness of the layer subsequently to be printed. The procedure is repeated to form three-dimensional object 120 in a layer-wise manner.

In another embodiment, tray 360 may be displaced in the Z direction between forward and reverse passages of the dispensing head of unit 16, within the layer. Such Z displacement is carried out in order to cause contact of the leveling device with the surface in one direction and prevent contact in the other direction.

While scanning, the apparatus 114 visits a plurality of target locations on the two-dimensional layer or surface, and decides, for each target location or a group of target locations, whether or not the target location or group of target locations is to be occupied by building material, and which type of building material is to be delivered thereto. The decision is made according to computer object data for the layer.

According to some embodiments of the present invention, prior and/or during printing, a pre-fabricated support structure 110 is positioned on building tray 360 to support geometry of object 120. Typically, pre-fabricated support structure 110 is not flat and/or covers a smaller area than a layer that is to be printed over structure 110. According to some embodiments of the present invention, user interface 116 provides information verifying use of a pre-fabricated support structure 110 and data processor 154 adjusts computer object data for layers that are to be printed over pre-fabricated support structure 110. According to some embodiments of the present invention, data processor 154 identifies one or more discrete volumes within and/or around object 120 requiring support structures, and also provides computer object data for fabrication of the support structures prior to beginning printing of object 120.

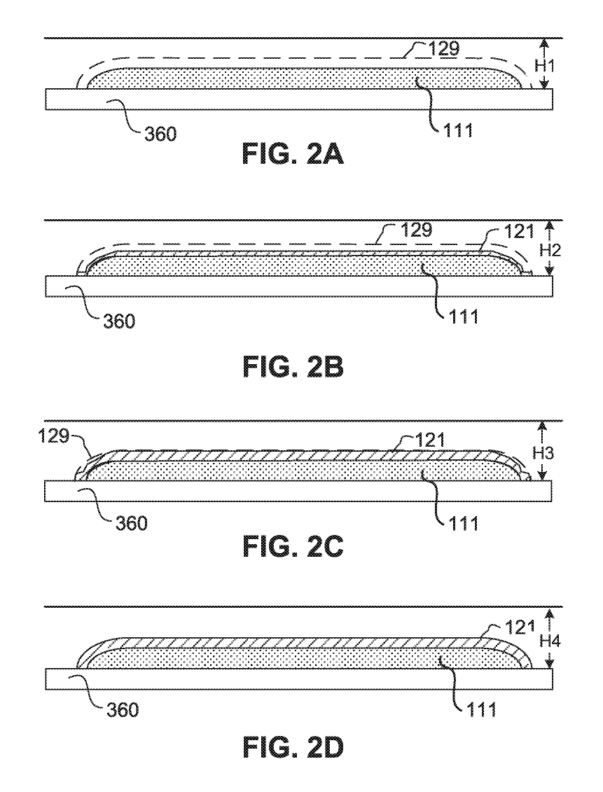

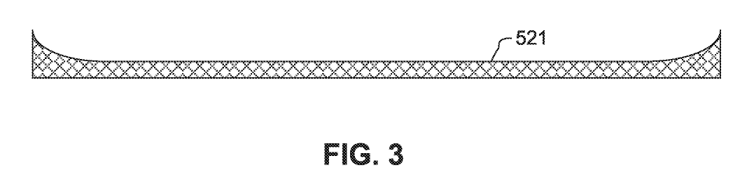

Reference is now made to FIGS. 2A, 2B, 2C and 2D illustrating simplified schematic drawings showing construction of an object with a prefabricated support structure over four exemplary steps and to FIG. 3 showing a simplified schematic drawing of exemplary computer object data adapted according to shape of a prefabricated support structure, all in accordance with some embodiments of the present invention in accordance with some embodiments of the present invention. According to some embodiments of the present invention, an object 121 is printed over a pre-fabricated support structure 111 having a curved surface, in a layer-wise manner until a final contour 129 of object 121 is reached. According to some embodiments of the present invention, a printing apparatus, e.g. apparatus 114 (FIG. 1) dispenses building material for a layer at a defined height above tray 360 and adjusts the height for each additional layer, e.g. H1, H2, H3 and H4. Typically, tray 360 is lowered prior to receiving an additional layer. According to some embodiments of the present invention, a material dispensed to form a layer falls to different distances due to curvature of pre-fabricated support structure 111. According to some embodiments of the present invention, the 3D printing apparatus is adapted to deposit material from a single layer from a distance ranging between 0.1 mm to 10 mm with sufficient accuracy.

According to some embodiments of the present invention, processing unit 154 adapts computer object data 521 for printing object 121 according to a shape of pre-fabricated support structure 111. In this exemplary embodiment shown in FIGS. 2A-2D, although object 121 has a constant thickness more layers are required to complete contour 129 along the edges as compared to the center, due to the curvature of pre-fabricated support structure 111.

In one example, a casing for a smartphone is fabricated by the system and methods described herein. A model of the smartphone may be pre-fabricated and used as a support structure, e.g. support structure 111 for constructing the casing, e.g. object 121. The smartphone shaped support structure may optionally be constructed by 3D printing with standard rigid modeling material and will have geometry of the smartphone. Prior to being used for printing, the support structure may be coated with material such as PE film, to form a non-adhesive intervenient layer between the support structure and the casing. According to some embodiments of the present invention, the casing is printed over the support structure so that the inner part of the casing will have the same geometry as the support structure. The outer part of the casing can have any desired shape, e.g. 3D shape.

Optionally, during construction of object 121 both modeling material and supporting material are dispensed for fabricating a desired shape of object 121 over structure 111. Typically, structure 111 is detached from object 121 once printing is completed.

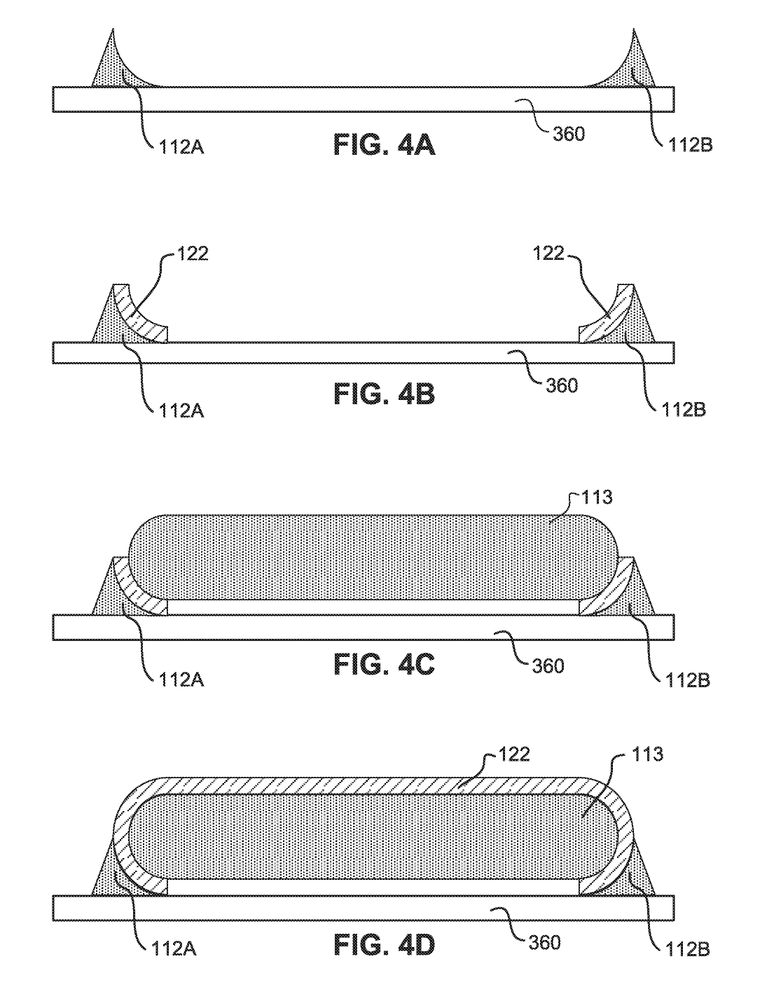

Reference is now made to FIGS. 4A, 4B, 4C and 4D illustrating simplified schematic drawings showing construction of an object with a plurality of prefabricated support structures over four exemplary steps in accordance with some embodiments of the present invention. FIGS. 4A, 4B, 4C and 4D show an example where a plurality of pre-fabricated support structures are used to construct an object 122. In this exemplary embodiment, a pair of pre-fabricated support structures 112, e.g. 112A and 112B are positioned on building tray 360 prior to printing and a portion of object 122 is printed on structures 112. In this exemplary embodiment, during a defined stage of the printing process, an additional pre-fabricated support structure 113 is added before continuing the printing process. Typically, each of structures 112 and 113 are coated with a non-adhesive intervenient layer for facilitating detachment of object 122 from structures 112 and 113 after printing is completed.

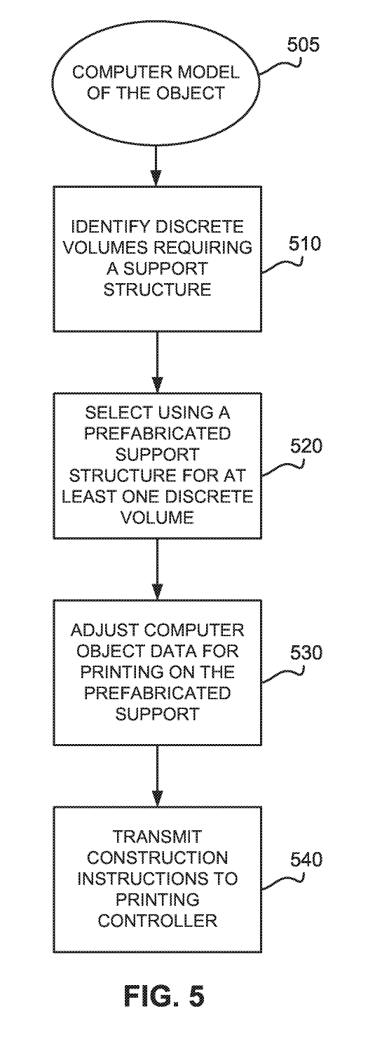

Reference is now made to FIG. 5 showing a simplified block diagram of an exemplary method for adjusting 3D printing for printing on prefabricated support structures in accordance with some embodiments of the present invention. According to some embodiments of the present invention, a computer model of an object for manufacture is computed (block 505) and a processor identifies discrete volumes requiring a support structure (block 510). Typically, the discrete volumes requiring a support structure depends on the orientation of the object on the building tray and the processor is adapted to identify discrete volumes for different orientations of the object. According to some embodiments of the present invention, a processor selects using a prefabricated support structure for at least one discrete volume (block 520). According to some embodiments of the present invention, a processor defines computer object data for printing on the prefabricated support (block 530). Once defined, the process transmits construction instructions to printing controller for printing the object (block 540).

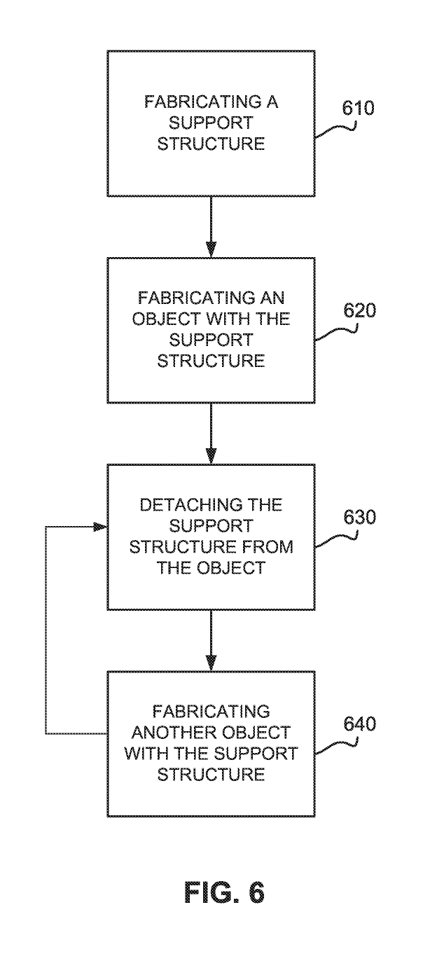

Reference is now made to FIG. 6 showing a simplified block diagram of an exemplary method for 3D printing with prefabricated support structures in accordance with some embodiments of the present invention. According to some embodiments of the present invention, prior to fabricating an object, a support structure for that object is fabricated (block 610). Optionally, the support structure is fabricated by 3D printing using modeling material. Optionally, support material may be used in addition to modeling material. Alternatively, the support structure is fabricated by other methods including molding or milling with CNC. Typically, at least a portion of the support structure is coated with a material that facilitates separating the object from the prefabricated support structure.

According to some embodiments of the present invention, once the support structure is prepared it is used as a support structure for fabricating the desired object with 3D printing (block 620). Typically, the object is at least partially constructed over the support structure. Once the object is completed, the support structure is removed from the object (block 630). Typically, the support structure is structured to stay intact while being detached from the object for construction. According to some embodiments of the present invention, once the support structure is removed, another object is printed with the support structure (block 640). Typically, the method including fabricating an object with the support structure and then separating the support structure from the object is repeated until all the objects are produced.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

1. A system comprising:
a three-dimensional (3D) printer comprising:
a dispensing unit for selectively dispensing building material in a layer-wise manner for building an object;
a building tray for supporting the dispensed material for building the object; and
a radiation sources for curing or solidifying the building material by electromagnetic radiation, being operable to adjust the intensity of the electromagnetic radiation according to a distance between a portion of the layer to be cured or solidified and said radiation source;
a processor configured to compute object data for printing the object, wherein the object data is defined in a layer-wise manner to follow a contour of a prefabricated support structure over which at least a portion of the object is built and wherein the object data of one layer defines selective dispensing to different distances; and
a controller configured to control the dispensing of the building material in the layer-wise manner based on the object data.

2. The system of claim 1, comprising a prefabricated support structure configured to support a shape of the object, wherein at least a portion of the building material is dispensed over the prefabricated support structure and wherein the prefabricated support structure is configured to be reusable.

3. The system of claim 2, wherein the prefabricated support structure is formed by an additive manufacturing process.

4. The system of claim 2, wherein the prefabricated support structure is formed with modeling material or with support material that is coated with a lacquer or with polyethylene (PE) film.

5. The system according to claim 1, wherein the prefabricated support structure is configured to be separated from the object after construction of the object.

6. The system according to claim 1, wherein the processor is configured to identify a discrete volume requiring a support structure from a computer model of the object and to adapt the object data to follow a contour of the volume.

7. The system according to claim 1, wherein the building material includes modeling material.

8. The system according to claim 7, wherein the building material includes support material.

9. A method comprising:
selecting a prefabricated support structure for supporting geometry of an object during manufacturing by 3D printing;
computing object data for printing the object, wherein the object data is defined in a layer-wise manner and object data of a layer is defined to follow a contour of the prefabricated support structure that is curved or angled;
dispensing building material selectively over the prefabricated support structure in a layer-wise manner to manufacture the object; and
a radiation source applying electromagnetic radiation, wherein an intensity of the electromagnetic radiation is adjusted according to the distance between a portion of the layer to be cured and said radiation source.

10. The method of claim 9, wherein the building material of the layer is dispensed to different distances.

11. The method of claim 9, comprising separating the prefabricated support structure from the object after manufacturing the object.

12. The method according to claim 9, comprising reusing the prefabricated support structure for manufacturing an additional object.

13. The method according to claim 9, wherein the prefabricated support structure is formed by an additive manufacturing process, by milling with computer numerical control (CNC) or by molding.

14. The method according to claim 9, wherein the prefabricated support structure is formed by 3D printing with modeling material.

15. The method according to claim 9, wherein the prefabricated support structure is formed by 3D printing with support material that is coated with lacquer or with polyethylene (PE) film.

16. The method according to claim 9, wherein the prefabricated support structure is manufactured by injection molding.

17. The method according to claim 9, wherein the prefabricated support structure is formed with metal.

18. The method according to claim 9, wherein the prefabricated support structure is coated with a film.

19. The method according to claim 9, wherein the building material is modeling material.

20. The method according to claim 19, wherein the building material includes support material.

21. The method according to claim 9 comprising:
identifying a discrete volume requiring a support structure from a computer model of the object; and
manufacturing the prefabricated support structure in the shape of the discrete volume.

22. The method according to claim 13, wherein said molding comprises injection molding.
